(19) United States
(12) Patent Application Publication
(10) Pub. No.: US 2024/0352370 A1
(43) Pub. Date: Oct. 24, 2024

(54) EQUIPMENT FOR MANUFACTURING BIOMASS SOLID FUEL

(71) Applicant: IDEMITSU KOSAN CO.,LTD., Tokyo (JP)

(72) Inventors: Takuya FURUZONO, Tokyo (JP); Kento OKANIWA, Tokyo (JP); Hidetoshi SUZUKI, Tokyo (JP); Masashi MACHIDA, Tokyo (JP); Kazuyuki HIGASHINO, Tokyo (JP); Gouki TSUJI, Tokyo (JP)

(73) Assignee: IDEMITSU KOSAN CO.,LTD., Tokyo (JP)

(21) Appl. No.: 18/683,388

(22) PCT Filed: Jul. 4, 2022
(86) PCT No.: PCT/JP2022/026545

§ 371 Date: Feb. 13, 2024

(30) Foreign Application Priority Data
Aug. 19, 2021 (JP) 2021-134097

(51) Int. Cl. C10L 9/08

(52) U.S. Cl. CPC C10L 9/083

(57) ABSTRACT

A manufacturing facility of biomass solid fuel includes: a preheater for preheating pellets; a heat source for preheating; a reactor that torrefies the pellets preheated by the preheater; a circulation path that connects a gas outlet and a gas inlet of the reactor and circulates torrefaction gas generated during torrefaction of the pellets in the reactor, a branch flow path branched from the circulation path to flow the torrefaction gas therethrough; a combustor that receives the torrefaction gas flowing through the branch flow path and combusts the torrefaction gas; a first heat exchanger provided in the circulation path; and a first combustion gas flow path connecting the combustor and the first heat exchanger to flow combustion gas generated in the combustor. The first heat exchanger exchanges heat between the combustion gas generated in the combustor and the torrefaction gas circulating in the circulation path.

### TECHNICAL FIELD

The present invention relates to a manufacturing facility of biomass solid fuel.

### BACKGROUND ART

Coal-fired thermal power produces a large amount of CO₂ emission per emission intensity and poses great burden on the environment. In order to reduce the CO₂ emission from the coal-fired thermal power, mixed combustion of biomass, where biomass is mixed with coal to be combusted, has attracted increasing attention.

Mixed combustion of wood chips and wood pellets has already been put into practice. However, the biomass, which is inferior to coal in terms of crushability, shows about only several percentage of a maximum mixed combustion rate.

Accordingly, as a means for enhancing the mixed combustion rate of biomass, it has been studied to torrefy the biomass. By torrefying the biomass, a solid fuel with enhanced crushability can be produced. In addition, it is also possible to increase the mixed combustion rate with coal.

As an example, Patent Literature 1 discloses a manufacturing method of solid fuel, in which wood biomass crushed product of a size ranging from 5 to 60 mm is densified to a bulk density (measured according to JIS K 2151-6 “test method for bulk density”) of 0.5 g/cm3 or more and is torrefied under conditions of oxygen concentration of 10% or less and torrefaction temperature ranging from 170 to 350 degrees C.

As another example, Patent Literature 2 discloses a biomass solid fuel formed of biomass powder having a fuel ratio (solid carbon/volatile matter content) of 0.2 to 0.8, a dry-basis higher calorific value of 4800 to 7000 (kcal/kg), a molar ratio O/C of oxygen (O) to carbon (C) of 0.1 to 0.7, and a molar ratio H/C of hydrogen (H) to carbon (C) of 0.8 to 1.3.

### CITATION LIST

### Patent Literature(s)

Patent Literature 1: JP 2015-189958 A

Patent Literature 2: International Publication No. WO 2016/056608

### SUMMARY OF THE INVENTION

### Problem(s) to be Solved by the Invention

Regarding a solid fuel such as a wood pellet, for instance, the solid fuel disintegrates when getting wet with water and thus needs to be stored in a silo or the like, whereas a solid fuel that is a torrefied biomass (hereinafter, sometimes also referred to as “black pellet”) is hydrophobic and can thus be stored outdoors, which advantageously eliminates the necessity of a facility such as a silo.

However, in a case where black pellets are stored outdoors, elution of an organic component (e.g. COD component) is of concern. Almost no organic component is eluted from coal, whereas an organic component is eluted from the black pellets. Therefore, it is of concern that outdoor storage of the black pellets would have an influence on the environment.

Thus, it is necessary to reduce the elution of the organic component as far as possible when the black pellets are to be stored outdoors. For that purpose, a manufacturing facility capable of manufacturing black pellets of a structure, from which the organic component is not easily eluted, has been demanded.

An object of the invention is to provide a manufacturing facility of biomass solid fuel capable of manufacturing biomass solid fuel, from which an organic component is unlikely to be eluted.

### Means for Solving the Problem(s)

According to an aspect of the invention, there is provided a manufacturing facility of biomass solid fuel configured to torrefy pellets containing biomass to produce a biomass solid fuel, the manufacturing facility including: a preheater configured to preheat the pellets; a heat source for preheating; a reactor configured to torrefy the pellets preheated by the preheater; a circulation path connecting a gas outlet of the reactor and a gas inlet of the reactor and configured to circulate a torrefaction gas generated during torrefaction of the pellets in the reactor; a branch flow path branched from the circulation path and configured to flow the torrefaction gas therethrough; a combustor configured to receive the torrefaction gas flowing through the branch flow path and combust the torrefaction gas; a first heat exchanger provided in the circulation path; and a first combustion gas flow path connecting the combustor and the first heat exchanger and configured to flow the combustion gas therethrough that is generated in the combustor, the first heat exchanger being configured to exchange heat between the combustion gas generated in the combustor and the torrefaction gas circulating in the circulation path.

In the manufacturing facility of biomass solid fuel according to the above aspect of the invention, it is preferable that the manufacturing facility further includes a heat generator connected to the preheater and configured to generate a heating gas; and a heating gas introduction passage configured to introduce the heating gas generated in the heat generator into the preheater, in which the heating gas is the heat source for preheating.

In the manufacturing facility of biomass solid fuel according to the above aspect of the invention, it is preferable that the heat generator is a heater configured to heat a to-be-heated gas to generate the heating gas.

In the manufacturing facility of biomass solid fuel according to the above aspect of the invention, it is preferable that the manufacturing facility further includes a second combustion gas flow path connecting the first heat exchanger and the heat generator and configured to flow the combustion gas therethrough, heat of which is exchanged in the first heat exchanger, in which the heat generator is configured to heat a to-be-heated gas with use of heat of the combustion gas flowing through the second combustion gas flow path to generate the heating gas.

In the manufacturing facility of biomass solid fuel according to the above aspect of the invention, it is preferable that the heating gas is generated by heating the to-be-heated gas with use of heat of the combustion gas.

In the manufacturing facility of biomass solid fuel according to the above aspect of the invention, it is preferable that the manufacturing facility further includes a third combustion gas flow path connecting the first heat exchanger and the preheater, in which the combustion gas whose heat is exchanged in the first heat exchanger is introduced into the preheater through the third combustion gas flow path, and the combustion gas whose heat is exchanged in the first heat exchanger is the heat source for preheating.

In the manufacturing facility of biomass solid fuel according to the above aspect of the invention, it is preferable that the manufacturing facility further includes a fine powder separator provided between the gas outlet of the reactor and the first heat exchanger and configured to separate fine powder contained in the torrefaction gas generated in the reactor.

According to the above aspect of the invention, a manufacturing facility of biomass solid fuel capable of manufacturing biomass solid fuel, from which an organic component is unlikely to be eluted, can be provided.

### BRIEF DESCRIPTION OF DRAWING(S)

FIG. 1 is a diagram illustrating an arrangement of a manufacturing facility of biomass solid fuel according to a first exemplary embodiment.

FIG. 2 is a diagram illustrating an arrangement of a manufacturing facility of biomass solid fuel according to a second exemplary embodiment.

FIG. 3 is a diagram illustrating an arrangement of a manufacturing facility of biomass solid fuel according to a third exemplary embodiment.

FIG. 4 is a diagram illustrating an arrangement of a manufacturing facility of biomass solid fuel according to a fourth exemplary embodiment.

### DESCRIPTION OF EMBODIMENT(S)

Herein, numerical ranges represented by “x to y” represents a range whose lower limit is the value (x) recited before “to” and whose upper limit is the value (y) recited after “to.”

Herein, expressions using an ordinal number (e.g. “first”, “second”, and “third”), whose purpose is to distinguish among components, do not mean the order of the components.

### First Exemplary Embodiment

A manufacturing facility of biomass solid fuel (sometimes simply referred to as “manufacturing facility” hereinafter) according to a first exemplary embodiment will be described below with reference to the attached drawings.

### Overall Configuration

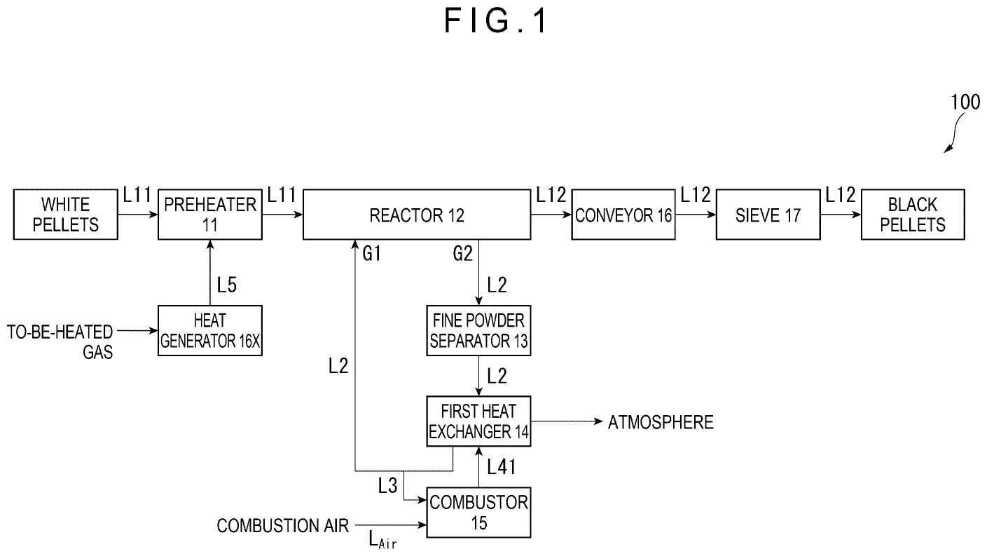

FIG. 1 is a diagram illustrating an exemplary arrangement of a manufacturing facility according to a first exemplary embodiment. In FIG. 1, “white pellets” refer to biomass pellets that have not been torrefied. In FIG. 1, L11 represents a path of the white pellets and L12 represents a path of biomass solid fuel (black pellets).

A manufacturing facility 100 illustrated in FIG. 1 is a facility for torrefying the pellets containing biomass (the “white pellets” in FIG. 1) to produce the biomass solid fuel.

In the first exemplary embodiment, description will be made on a case where a heat source for preheating the pellets using a preheater 11 (a heat source for preheating) is a heating gas generated in a heat generator 16X.

The manufacturing facility 100 includes the preheater 11 configured to preheat the pellets, a reactor 12 configured to torrefy the preheated pellets, a circulation path L2 connecting a gas outlet G2 of the reactor 12 to a gas inlet G1 of the reactor 12 to circulate a torrefaction gas generated when the pellets are torrefied in the reactor 12, a branch flow path L3 branched from the circulation path L2 and through which the torrefaction gas flows, a combustor 15 configured to combust the torrefaction gas introduced through the branch flow path L3, a fine powder separator 13 provided in the circulation path L2, a first heat exchanger 14 provided in the circulation path L2, a first combustion gas flow path L41 connecting the combustor 15 to the first heat exchanger 14 and through which the combustion gas generated in the combustor 15 flows, a heat generator 16X configured to generate the heating gas (the heat source for preheating), and a heating gas introduction passage L5 through which the heating gas generated in the heat generator 16X is introduced to the preheater 11.

The first heat exchanger 14 is configured to exchange heat between the combustion gas generated in the combustor 15 and the torrefaction gas circulating in the circulation path L2.

The manufacturing facility 100 further includes: a conveyor 16 configured to convey the black pellets produced in the reactor 12; and a sieve 17.

### Preheater 11

The preheater 11 is configured to preheat the pellets. Preheating refers to heating the pellets in advance before the pellets are introduced into the reactor 12 at a temperature (e.g. in a range from 30 degrees C. to 100 degrees C.) that does not cause the pellets to be torrefied. The temperature for the preheating is controlled by, for instance, a temperature controller (not illustrated). In the arrangement illustrated in FIG. 1, the heat source for preheating is the heating gas generated in the heat generator 16X. The heat generator 16X is configured to heat a to-be-heated gas to generate the heating gas.

### Reactor 12

The reactor 12 is configured to torrefy the pellets preheated by the preheater 11.

Torrefying (torrefaction) refers to carbonizing at least a part of the biomass. Accordingly, torrefied biomass (pellets) herein encompasses both of partially carbonized biomass and totally carbonized biomass. The torrefied pellets (black pellets) are obtained by heating the white pellets at a temperature, for instance, in a range from 200 degrees C. to 300 degrees C. The torrefaction temperature is controlled by, for instance, a temperature controller (not illustrated).

### Fine Powder Separator 13

The fine powder separator 13 is provided between the gas outlet G2 of the reactor 12 and the first heat exchanger 14 to separate fine powder contained in the torrefaction gas generated in the reactor 12.

Examples of the fine powder separator 13, which are not exhaustive, include a cyclone separator, a screen separator, and a bag filter.

### First Heat Exchanger 14

The first heat exchanger 14 is configured to exchange heat (transfer heat) between the combustion gas generated in the combustor 15 and the torrefaction gas circulating in the circulation path L2.

### Combustor 15

The combustor 15 is configured to combust the torrefaction gas introduced through the branch flow path L3. In the arrangement illustrated in FIG. 1, the torrefaction gas flowing through the branch flow path L3 and combustion air flowing through a path LAir are introduced into the combustor 15. The combustor 15 is configured to combust the torrefaction gas together with the combustion air introduced through the path LAir.

### Heat Generator 16X

The heat generator 16X, which is connected to the preheater 11, is configured to generate the heating gas (the heat source for preheating). In the arrangement illustrated in FIG. 1, the heat generator 16X is configured to heat the to-be-heated gas to generate the heating gas. The heating gas generated in the heat generator 16X is introduced into the preheater 11 through the heating gas introduction passage L5.

A typical example of the heat generator 16X, which is not particularly limited, is a heater. Examples of the heater include a heating furnace and a heat exchanger. As the to-be-heated gas, which is not particularly limited, at least one of air or inactive gases (e.g. nitrogen) is used.

In terms of effective energy utilization, it is preferable to use the gas generated in the manufacturing facility 100 in order to generate the heating gas. Examples of the gas generated in the manufacturing facility 100 include the torrefaction gas generated in the reactor 12 and the combustion gas generated in the combustor 15.

### Operations

The biomass solid fuel (black pellets) is manufactured as follows in the manufacturing facility 100 of the first exemplary embodiment.

The pellets (white pellets) are introduced into the preheater 11. The heating gas generated in the heat generator 16X is also introduced into the preheater 11 through the heating gas introduction passage L5. In the preheater 11, the pellets are preheated using the heating gas as the heat source.

The preheated pellets are discharged from the preheater 11 and introduced into the reactor 12. In the reactor 12, the pellet are torrefied at a predetermined temperature to become the black pellets. The torrefaction gas generated in the reactor 12 is discharged through the gas outlet G2. Fine powder is removed from the torrefaction gas by the fine powder separator 13. Subsequently, the thus treated torrefaction gas is introduced into the first heat exchanger 14.

Meanwhile, the torrefaction gas flowing through the branch flow path L3 and combustion air flowing through the path LAir are introduced into the combustor 15. In the combustor 15, the torrefaction gas is combusted together with the combustion air. The combustion gas generated in the combustor 15 is introduced into the first heat exchanger 14 through the first combustion gas flow path L41.

The first heat exchanger 14 is configured to exchange heat (transfer heat) between the combustion gas generated in the combustor 15 and the torrefaction gas circulating in the circulation path L2. In the first heat exchanger 14, the heat of the combustion gas is exchanged with (i.e. transferred to) the torrefaction gas. The combustion gas whose heat is exchanged with the torrefaction gas is then discharged into the atmospheric air.

The black pellets produced in the reactor 12 pass through the path L12, during which the black pellets are conveyed by the conveyor 16 and sieved by the sieve 17.

### Advantage(s)

According to the manufacturing facility 100 of the first exemplary embodiment, the black pellets can be manufactured with effective use of the energy generated in the manufacturing facility 100.

In addition, since the pellets preheated by the preheater 11 are introduced into the reactor 12 in the manufacturing facility 100, moisture can be restrained from being adsorbed on the surface of the pellets immediately after being introduced into the reactor 12. As a result, black pellets whose surface is restrained from being degraded and from which the organic component is not easily eluted can be obtained. This is considered to be because the preheating makes it difficult for components coating the pellets, which are supposed to be derived from lignin, to dissolve.

In addition, the manufactured black pellets, which are hydrophobic, can be stored outdoors.

### Second Exemplary Embodiment

A second exemplary embodiment will be described below, where difference(s) from the first exemplary embodiment will be focused and the same or similar components/features will be, for instance, denoted by the same reference numerals, thereby omitting or simplifying the description thereof.

### Overall Configuration

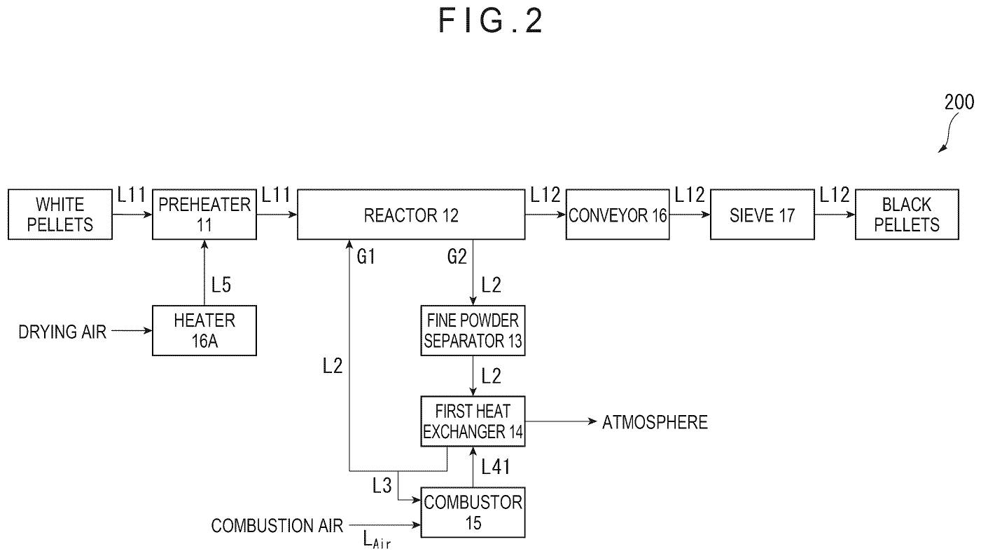

FIG. 2 is a diagram illustrating an exemplary arrangement of a manufacturing facility according to the second exemplary embodiment.

In the second exemplary embodiment, description will be made on a case where the heat source for preheating the pellets in the preheater 11 is drying air (an example of the heating gas) directly heated by a heater 16A.

A manufacturing facility 200 illustrated in FIG. 2 includes the heater 16A (heat generator). In FIG. 2, the heater 16A is a heating furnace.

The manufacturing facility 200 according to the second exemplary embodiment is different from that of the first exemplary embodiment in that the heater 16A is provided as the heat generator. The rest of the arrangement in the second exemplary embodiment is the same as in the first exemplary embodiment.

### Operations

The biomass solid fuel (black pellets) is manufactured as follows in the manufacturing facility 200 of the second exemplary embodiment. The following description will be focused on the difference from the first exemplary embodiment.

The heater 16A (a heating furnace in the arrangement of FIG. 2) is configured to directly heat the drying air (to-be-heated gas) to generate the heating gas. The generated heating gas is introduced into the preheater 11 through the heating gas introduction passage L5. The pellets in the preheater 11 are preheated using the heating gas as the heat source.

### Advantage(s)

According to the manufacturing facility 200 of the second exemplary embodiment, black pellets, from which the organic component is not easily eluted, can be manufactured.

### Third Exemplary Embodiment

A third exemplary embodiment will be described below, where difference(s) from the first exemplary embodiment will be focused and the same or similar components/features will be, for instance, denoted by the same reference numerals, thereby omitting or simplifying the description thereof.

### Overall Configuration

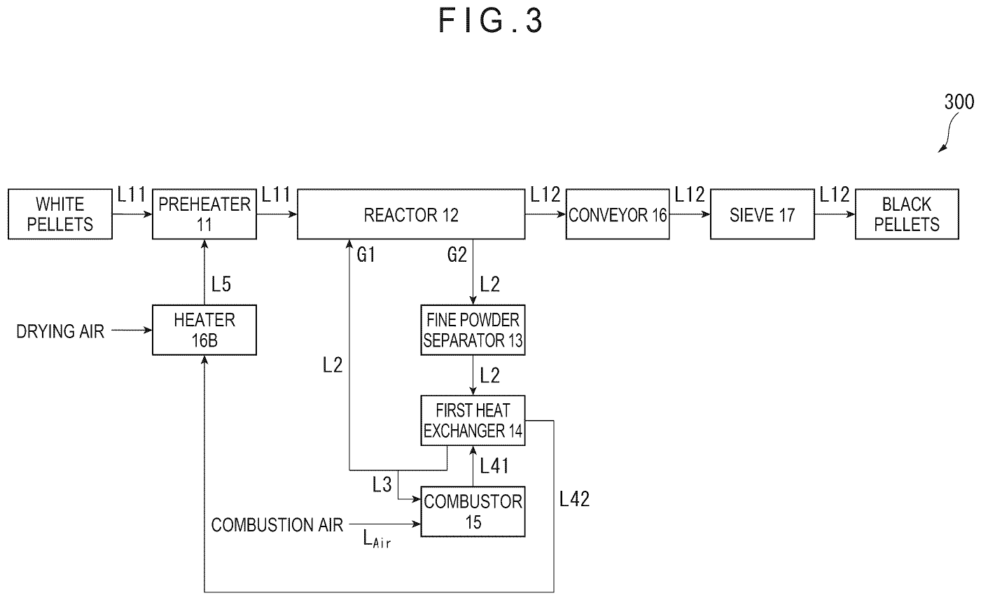

FIG. 3 is a diagram illustrating an exemplary arrangement of a manufacturing facility according to the third exemplary embodiment.

In the third exemplary embodiment, description will be made on a case where the heat source for preheating the pellets in the preheater 11 is heat-exchanged drying air (an example of the heating gas).

A manufacturing facility 300 illustrated in FIG. 3 includes a heater 16B (heat generator) and a second combustion gas flow path L42 connecting the first heat exchanger 14 and the heater 16B. The combustion gas heat-exchanged in the first heat exchanger 14 flows through the second combustion gas flow path L42. In FIG. 3, the heater 16B is a second heat exchanger.

The manufacturing facility 300 according to the third exemplary embodiment is different from that of the first exemplary embodiment in that the heater 16B (the heat generator) and the second combustion gas flow path L42 are provided. The rest of the arrangement in the third exemplary embodiment is the same as in the first exemplary embodiment.

### Operations

The biomass solid fuel (black pellets) is manufactured as follows in the manufacturing facility 300 of the third exemplary embodiment. The following description will be focused on the difference from the first exemplary embodiment.

The combustion gas heat-exchanged in the first heat exchanger 14 is introduced into the heater 16B (the second heat exchanger in the arrangement of FIG. 3) after flowing through the second combustion gas flow path L42.

The heater 16B is configured to exchange (i.e. transfer) the heat of the combustion gas (the heat of the combustion gas heat-exchanged in the first heat exchanger 14) with the drying air (to-be-heated gas) to generate the heating gas. The generated heating gas is introduced into the preheater 11 through the heating gas introduction passage L5.

The pellets in the preheater 11 are preheated using the heating gas as the heat source.

### Advantage(s)

According to the manufacturing facility 300 of the third exemplary embodiment, the black pellets, from which organic component is not easily eluted, can be manufactured with effective use of the energy generated in the manufacturing facility 300.

### Fourth Exemplary Embodiment

A fourth exemplary embodiment will be described below, where difference(s) from the third exemplary embodiment will be focused and the same or similar components/features will be, for instance, denoted by the same reference numerals, thereby omitting or simplifying the description thereof.

### Overall Configuration

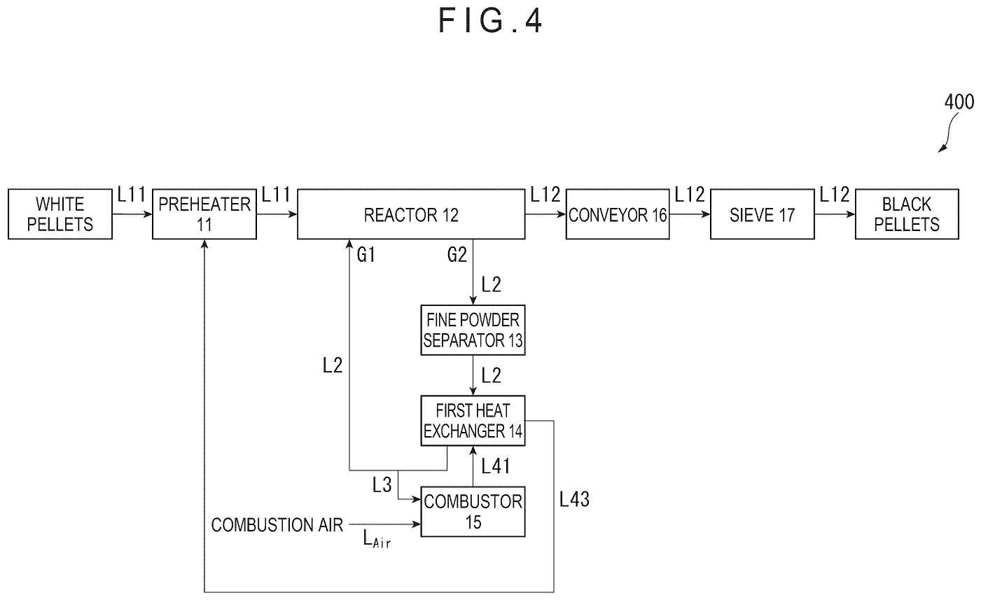

FIG. 4 is a diagram illustrating an exemplary arrangement of a manufacturing facility according to the fourth exemplary embodiment.

In the fourth exemplary embodiment, description will be made on a case where the heat source for preheating the pellets in the preheater 11 (a heat source for preheating) is combustion gas (in FIG. 4, combustion gas heat-exchanged in the first heat exchanger 14).

A manufacturing facility 400 illustrated in FIG. 4 includes a third combustion gas flow path L43 connecting the first heat exchanger 14 and the preheater 11. The combustion gas heat-exchanged in the first heat exchanger 14 flows through the third combustion gas flow path L43.

In other words, the manufacturing facility 400 described in the fourth exemplary embodiment is different from the third exemplary embodiment in that the combustion gas heat-exchanged in the first heat exchanger 14 is directly introduced into the preheater 11. The rest of the arrangement in the fourth exemplary embodiment is the same as in the third exemplary embodiment.

### Operations

The biomass solid fuel (black pellets) is manufactured as follows in the manufacturing facility 400 of the fourth exemplary embodiment. The following description will be focused on the difference from the third exemplary embodiment.

The combustion gas heat-exchanged in the first heat exchanger 14 is directly introduced into the preheater 11 through the third combustion gas flow path L43.

The pellets in the preheater 11 are preheated using the combustion gas directly introduced into the preheater 11 as the heat source.

### Advantage(s)

According to the manufacturing facility 400 of the fourth exemplary embodiment, black pellets, from which the organic component is not easily eluted, can be manufactured.

Further, with the use of the manufacturing facility 400 of the fourth exemplary embodiment, it is not necessary to install a heat generator (e.g. a heater). However, since the combustion gas having been heat-exchanged in the first heat exchanger 14 is of high temperature and contains air (oxygen), it is preferable to adjust the flow rate, temperature and the like of the combustion gas when the combustion gas is introduced into the preheater 11.

### Other Exemplary Embodiment

The heat of the combustion gas is exchanged with the drying air using the single second heat exchanger (i.e. the heater 16B) in the third exemplary embodiment. However, the arrangement for the heat exchange in the third exemplary embodiment is not exhaustive. For instance, a plurality of heat exchangers are optionally used to exchange the heat of the combustion gas with the drying air in stages.

In the third exemplary embodiment, the combustion gas generated in the combustor 15 is, for instance, optionally directly introduced into the second heat exchanger without passing through the first heat exchanger 14. In this arrangement, the heat of the combustion gas generated in the combustor 15 is exchanged with the drying air.

In the fourth exemplary embodiment, for instance, the combustion gas generated in the combustor 15 is optionally directly introduced into the preheater 11 without passing through the first heat exchanger 14. In this arrangement, the combustion gas generated in the combustor 15 is used as the heat source for preheating the pellets.

### INDUSTRIAL APPLICABILITY

The manufacturing facility of the biomass solid fuel according to the invention is usable as a facility installed in a power generation plant, a steel plant, and a factory for biomass power generation and mixed power generation using biomass and coal.

### EXPLANATION OF CODES

11 . . . preheater, 12 . . . reactor, 13 . . . fine powder separator, 14 . . . first heat exchanger, 15 . . . combustor, 16 . . . conveyor, 16X . . . heat generator, 16A, 16B . . . heater, 17 . . . sieve, 100, 200, 300, 400 . . . manufacturing facility

1. A manufacturing facility of biomass solid fuel configured to torrefy pellets comprising biomass to produce a biomass solid fuel, the manufacturing facility comprising:
a preheater configured to preheat the pellets;
a heat source for preheating;
a reactor configured to torrefy the pellets preheated by the preheater;
a circulation path connecting a gas outlet of the reactor and a gas inlet of the reactor and configured to circulate a torrefaction gas generated during torrefaction of the pellets in the reactor;
a branch flow path branched from the circulation path and configured to flow the torrefaction gas therethrough;
a combustor configured to receive the torrefaction gas flowing through the branch flow path and combust the torrefaction gas;
a first heat exchanger provided in the circulation path; and
a first combustion gas flow path connecting the combustor and the first heat exchanger and configured to flow the combustion gas therethrough that is generated in the combustor,
the first heat exchanger being configured to exchange heat between the combustion gas generated in the combustor and the torrefaction gas circulating in the circulation path.

2. The manufacturing facility of biomass solid fuel according to claim 1, further comprising:
a heat generator connected to the preheater and configured to generate a heating gas; and
a heating gas introduction passage configured to introduce the heating gas generated in the heat generator into the preheater, wherein
the heating gas is the heat source for preheating.

3. The manufacturing facility of biomass solid fuel according to claim 2, wherein
the heat generator is a heater configured to heat a to-be-heated gas to generate the heating gas.

4. The manufacturing facility of biomass solid fuel according to claim 2, further comprising:
a second combustion gas flow path connecting the first heat exchanger and the heat generator and configured to flow the combustion gas therethrough, heat of which is exchanged in the first heat exchanger, wherein
the heat generator is configured to heat a to-be-heated gas with use of heat of the combustion gas flowing through the second combustion gas flow path to generate the heating gas.

5. The manufacturing facility of biomass solid fuel according to claim 3, wherein the heating gas is generated by heating the to-be-heated gas with use of heat of the combustion gas.

6. The manufacturing facility of biomass solid fuel according to claim 1, further comprising:
a third combustion gas flow path connecting the first heat exchanger and the preheater, wherein
the combustion gas whose heat is exchanged in the first heat exchanger is introduced into the preheater through the third combustion gas flow path, and
the combustion gas whose heat is exchanged in the first heat exchanger is the heat source for preheating.

7. The manufacturing facility of biomass solid fuel according to claim 1, further comprising:
a fine powder separator provided between the gas outlet of the reactor and the first heat exchanger and configured to separate fine powder contained in the torrefaction gas generated in the reactor.
